(19) United States
(12) Patent Application Publication
(10) Pub. No.: US 2024/0424550 A1
(43) Pub. Date: Dec. 26, 2024

(54) HAND-HELD PULLING AND COMPRESSION DEVICE

(71) Applicant: TKR Spezialwerkzeuge GmbH, Gevelsberg (DE)

(72) Inventor: Torsten KREISCHER, Wetter (DE)

(21) Appl. No.: 18/752,729

(22) Filed: Jun. 24, 2024

(30) Foreign Application Priority Data
Jun. 26, 2023 (DE) 10 2023 116 746.4

(51) Int. Cl. B21J 15/26; B21J 15/10; B21J 15/38

(52) U.S. Cl. CPC B21J 15/26; B21J 15/105; B21J 15/38

(57) ABSTRACT

The invention relates to a hand-held pulling and compression device for driving interchangeable tools, with a drive unit comprising a battery-operated electric motor, a screw drive with a threaded spindle connected to the drive unit and rotatably mounted on a housing body, and a threaded nut mounted rotatably on the threaded spindle and non-rotatably on the housing body via a bearing unit, and a coupling unit connected to a tool holder for transmitting tensile and compressive forces resulting from the direction of rotation of the threaded spindle from the threaded nut to the tool holder. In order to provide a hand-held pulling and compression device that can be used flexibly, it is provided that the housing body has a connection section for detachable fixing of a tool device to the pulling and compression device.

The invention relates to a hand-held pulling and compression device for driving interchangeable tools, with
a drive unit with a battery-operated electric motor,
a screw drive with a threaded spindle connected to the drive unit and mounted non-rotatably on a housing body, and a threaded nut mounted rotatably on the threaded spindle and non-rotatably on the housing body via a bearing unit, and
a coupling unit connected to a tool holder for transmitting tensile and compressive forces resulting from the direction of rotation of the threaded spindle from the threaded nut to the tool holder.

Hand-held pulling and compression devices, i.e. devices which can be used by a person on a mobile basis, such as hand-held, electric riveting and pressing devices for setting blind rivet elements, such as blind rivets and blind rivet nuts, or for carrying out punching processes and for setting punch rivets, which have a drive unit with an electric motor-driven threaded spindle of a screw drive, are known from the prior art in a wide variety of embodiments. The screw drive converts a rotational movement of the electric motor into a linear movement of the pulling and pressing tool in a known manner. In the case of the setting operation of a blind rivet element, for example, a mandrel of the blind rivet element is moved axially.

The riveting and pressing devices described above are used, for example, in vehicle workshops to carry out repair work on the bodywork of vehicles and for maintenance work on tube or cable connections. Depending on the work to be carried out, it is necessary to drive a wide variety of different interchangeable tools with the riveting and pressing devices. Even known hand-held devices that enable the operation of both pulling and pressing tools have the disadvantage of limited connection and/or drive options for interchangeable tools.

On this basis, the invention is based on the object of providing a hand-held pulling and compression device that can be used flexibly.

The invention solves the object by a hand-held pulling and compression device with the features of claim 1. Advantageous further embodiments of the invention are given in the dependent claims.

A characteristic feature of the hand-held pulling and compression device according to the invention is that the housing body of the hand-held pulling and compression device has a connection section for detachably fixing a tool device to the pulling and compression device.

Tool devices are different structural units that can be driven by the tension-/compression device, which may, for example, be devices for converting the tensile and compressive forces or other types of adapters. If the hand-held pulling and compression device is designed in such a way that it can also be used to drive rotationally operated tool devices, the tool device can, for example, also be formed by an articulated device which allows the tool device to be pivoted relative to the pulling and compression device.

The design of the housing body of the hand-held pulling and compression device according to the invention with a connection section for the detachable fixing of different tool devices to the pulling and compression device makes it possible, with a corresponding design of the tool device, to arrange these on the hand-held pulling and compression device according to the application. By providing a, preferably standardized, connection section, it is thus possible to increase the range of use of the hand-held pulling and compression device to a considerable extent, whereby a wide range of work can be carried out by means of different tool devices using the hand-held pulling and compression device, in particular if, according to a further development of the invention, the latter is also designed to drive rotationally operated tool devices.

In principle, the tool devices can be fixed to the housing body of the hand-held pulling and compression device in any way. It is conceivable here, for example, that the connection section is designed with a thread, which makes it possible to fix tool devices with corresponding threads to the connection section of the pulling and compression device. According to an advantageous embodiment of the invention, however, it is provided that the connection section has a quick coupling that can be adjusted between a locked position and an unlocked position.

The use of a quick coupling, which is characterized in that it can be quickly adjusted by the operator with little effort between the unlocked position, in which a tool device can be arranged on or removed from the connection section, and the locked position, in which a tool device is fixed to the connection section of the pulling and compression device. The quick coupling is characterized in particular by the fact that additional tools for removing or arranging the tool devices can be dispensed with. A design of the hand-held pulling and compression device with a quick coupling thus enables a quick and convenient change or mounting and demounting of a tool device on or from the pulling and compression device.

In principle, the quick coupling can be adjusted between the unlocked and locked positions in any way, e.g. the quick coupling can be designed in such a way that it can be mechanically adjusted between the unlocked position and the locked position by an operator. According to an advantageous further development of the invention, however, it is provided that the quick coupling can be adjusted between the unlocked position and the locked position by means of an electric drive device.

The use of an electric drive device to operate the quick coupling, i.e. to adjust it between the unlocked and locked positions, increases the comfort of the hand-held pulling and compression device in a special way. Incorrect operation of the quick couplings is also minimized or completely avoided by an electric drive device.

An additional increase in operational safety can be achieved by a further advantageous embodiment of the hand-held pulling and compression device in that the quick coupling has a sensor unit for detecting the status and a display unit connected to the sensor unit for indication of the status of the quick coupling. According to this embodiment of the invention, the state of the quick coupling can be detected by means of the sensor unit, i.e. in particular, it is determined whether it is in the unlocked or locked position. The state detected by the sensor unit can then be indicated to an operator of the pulling and compression device via a display unit, which is, for example, suitable signal lamps, whereby the operational safety can be increased in a supplementary manner.

According to a further embodiment of the invention, it is further provided that the sensor unit is designed with a communication unit for transmitting the state detected to the drive unit. According to this embodiment of the invention, the state of the quick coupling determined by the sensor unit is transmitted by means of the communication unit to the drive unit or to a control unit controlling the drive unit. In a corresponding embodiment of the control unit, operation of the tension-/compression device can thus be blocked if the sensor unit does not indicate to the drive unit that the quick coupling is in an operationally safe position.

To transmit the sensor data to the drive unit via the communication unit, the communication unit can be designed in any way, for example it can be designed for both wireless and wired data transmission, with the Bluetooth standard preferably being used for wireless data transmission.

In principle, the quick coupling can be designed in any way, provided that it is ensured that it enables simple and quick adjustment between the unlocked and locked positions and thus quick replacement or mounting and demounting of the tool devices.

According to a further development of the invention, it is provided that the quick coupling has a ball latching mechanism with a locking ring and a coupling ring having a plurality of openings each with a ball latching body, wherein the locking ring arranged coaxially with the coupling ring, the coupling ring and the ball latching bodies are matched to one another in such a way that in the locked position the ball latching bodies are arranged partially in the openings in such a way that they protrude from an inner side of the coupling ring and are secured in position by the locking ring in this locking position, and in the unlocked position the ball latching bodies can be displaced into a release position.

A locking ring is understood to be a ring-shaped design, which preferably has a round cross-section. For better handling, it can, for example, have grip elements or a grippy structure on its outer side. The coupling ring is also arranged coaxially to the locking ring and, like the locking ring, is preferably circular in cross-section.

The openings in the coupling ring are adapted to the shape of the ball latching bodies. In order to avoid interference caused by the ball latching bodies sliding out of the openings, the openings are designed in such a way that the balls cannot get out of the inner side of the coupling rings. This can be achieved, for example, by making the openings slightly conical. The openings are shaped in such a way that they project beyond the inner side of the coupling ring in the locking position. The locking ring can be adjusted relative to the coupling ring in such a way that, in the locked position, it secures the ball latching bodies in the locking position, i.e. in the position in which the ball latching bodies protrude partially from the inner side of the coupling ring. In the unlocked position, the locking ring allows the ball latching bodies to be moved into the release position, in which they can be moved into the openings so that they no longer protrude from the inner side of the coupling ring.

A corresponding design of the pulling and compression device thus makes it possible to easily arrange a tool device on the connection section when the quick coupling is in the unlocked position. In this state, the ball latching bodies are in a position in the openings in which they no longer protrude from the inner side, so that a tool device can be arranged coaxially to the inner side of the coupling ring. A subsequent adjustment of the quick coupling into the locked position causes a displacement of the ball latching bodies in the direction of the inner side, so that these protrude partially from the inner side and come into engagement with a corresponding connecting section on the tool device and thus prevent a displacement in the longitudinal axis direction of the pulling and compression device, so that the tool device is reliably locked on the pulling and compression device. The further development of the quick coupling with a ball latching mechanism also enables the tool device to be rotatable relative to the pulling and compression device about its longitudinal axis.

For demounting the tool device, it is only necessary to adjust the locking ring to the unlocked position, which allows the ball latching bodies to be displaced into the openings so that they no longer protrude from the inner side, enabling the tool device to be removed.

To increase operational safety, according to a further development of the invention, a locking unit is provided which fixes the locking ring in the locked position. The locking unit can be, for example, a preferably spring-loaded locking bolt which locks the locking ring in the locked position, so that the locking ring can only be adjusted from the locked position to the unlocked position after a corresponding displacement of the locking unit, for example the locking bolt. Malfunctions or incorrect operation of the pulling and compression device are thus prevented in a supplementary manner.

According to a further embodiment of the invention, it is further provided that the locking ring is rotatable relative to the coupling ring between the locked position and the unlocked position. A corresponding embodiment of the invention is characterized by the fact that the installation space can thus be selected to be particularly small and, moreover, malfunctions of the quick coupling are effectively prevented.

An embodiment of the invention is explained below with reference to the drawings. The drawings show in:

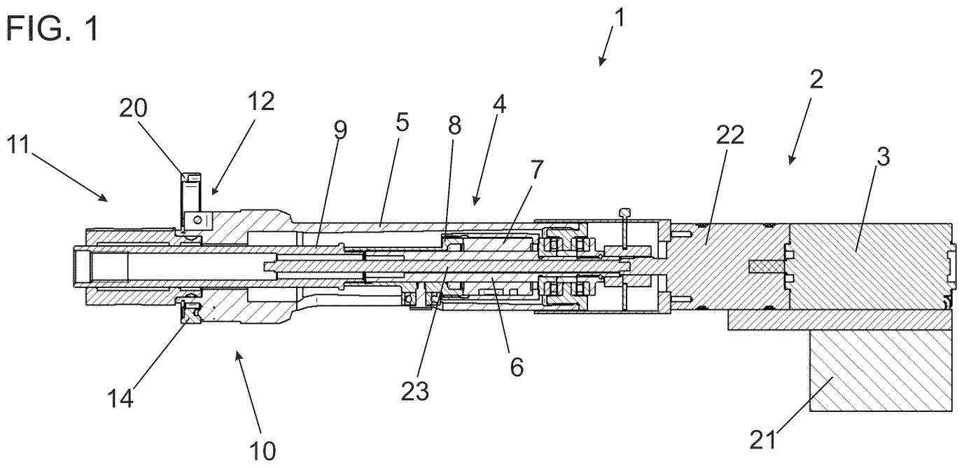

FIG. 1 a sectional view of a schematic representation of a pulling and compression device with a tool device connected to a connection section;

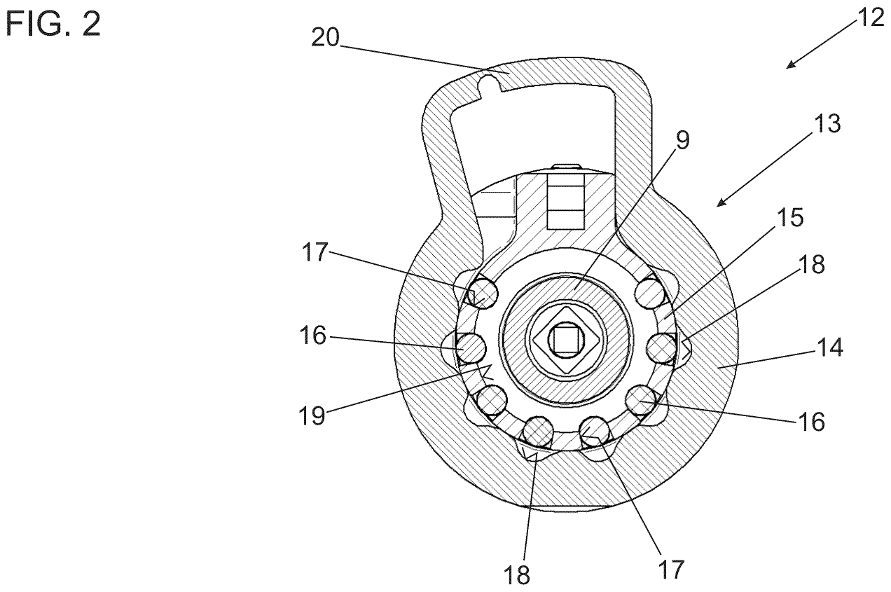

FIG. 2 a sectional view of a schematic representation of a quick coupling in an unlocked position and

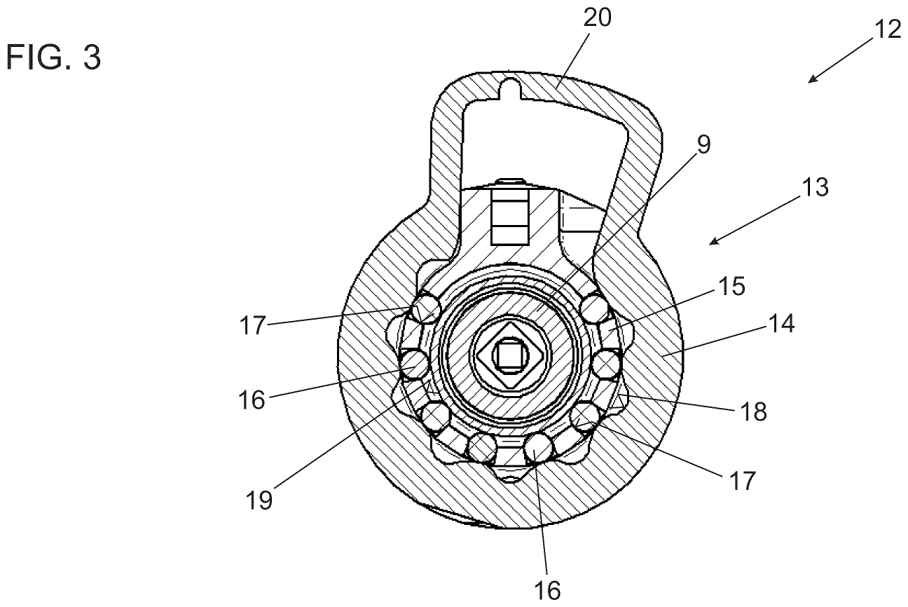

FIG. 3 a sectional view of a schematic representation of the quick coupling of FIG. 2 in a locked position.

FIG. 1 shows a schematic representation of a hand-held pulling and compression device 1 with a tool device 11 connected to a connection section 10 of the housing body 5 of the pulling and compression device 1.

For driving a threaded spindle 6 of a screw drive 4 the hand-held pulling and compression device 1 has a drive unit 2 with an electric motor 3, which can be controlled and regulated via a control unit 21. The drive unit 2 has an intermediate gear 22 for transmitting the rotational movements of the electric motor 3 to the threaded spindle 6.

Via the screw drive 4, the rotational movement of the threaded spindle 6 driven by the drive unit 2 is converted into a translational movement of a tool holder designed as a piston rod 9 and connected to a coupling unit 8. The coupling unit 8 is connected to a threaded nut 7, which is arranged non-rotatably with respect to the housing body 5 of the pulling and compression device 1, so that as a result of the rotational movement of the threaded spindle 6, the threaded nut 7 performs a linear movement along the longitudinal axis of the threaded spindle 6, which can be used to drive the tool holder designed as a piston rod 9.

In the embodiment example shown in FIG. 1, the threaded spindle 6 of the screw drive 4 is designed as a hollow shaft, within which a rotating shaft 23 extends coaxially. The rotating shaft 23 is connected non-rotatably to the drive unit 2, so that rotational movements generated by the drive unit 2 can be transmitted to corresponding tool devices 11 that can be connected to the connection section 10, independently of the adjustment travel of the threaded nut 7 on the threaded spindle 6. If the rotating shaft 23 is used to drive a tool device 11, the threaded spindle 6 is decoupled from the drive unit 2 on the pulling and compression device 1, so that only the rotating shaft 23 is set in rotation by the drive unit 2.

For the detachable connection of different tool devices 11 which are designed for connection to the coupling unit 8, the tool holder 9 and/or the rotating shaft 23, the connection section 10 of the housing body 5 of the pulling and compression device 1 has a quick coupling 12, which is shown in its unlocked position in FIG. 2 and in its locked position in FIG. 3.

The quick coupling 12 has an outer locking ring 14, a coupling ring 15 and ball latching bodies 16 arranged in openings 17, which together form a ball latching 13. The ball latching bodies 16 are arranged displaceably in the openings 17, the openings 17 being designed in such a way that in the locking position they project partially beyond the inner side 19 of the coupling ring 15, but the openings 17 being designed in such a way that the ball latching bodies 16 cannot be moved out of the openings 17 beyond the inner side 19.

In the unlocked position shown in FIG. 2, it is possible to displace the ball latching bodies 16 arranged in the locked position in the direction of the locking ring 14, whereby the ball latching bodies 16 are then displaced in corresponding recesses 18 on an inner side of the locking ring 14, so that the ball latching bodies 16 then no longer project beyond the inner side 19 of the coupling ring 15. In this position, it is then possible to arrange a tool device 11 adapted to the quick coupling 12 coaxially to the locking ring 14, or to remove an arranged tool device 11 from the connection section 10.

A tool device 11 arranged sectionally coaxially to the coupling ring 15 is secured in its position on the connection section 10 of the pulling and compression device 1 by a displacement of the locking ring 14 from the unlocked position shown in FIG. 2 to the locked position shown in FIG. 3, wherein the locking ring 14 then locks the ball latching bodies 16 in the locking position shown in FIG. 3, in which the ball latching bodies 16 protrude partially from the inner side 19 of the coupling ring 15 and produce a positive fit with a corresponding connecting section of the tool device 11 in the longitudinal axis direction of the pulling and compression device 1. For convenient adjustment, i.e. rotation of the locking ring 14 between the unlocked and locked positions by an operator, the locking ring 14 has a grip element 20. The quick coupling 12 offers the possibility of rotating the tool device 11 in the locked position about the longitudinal axis of the pulling and compression device 1.

### LIST OF REFERENCE SYMBOLS

1 Pulling and compression device
2 Drive unit
3 Electric motor
4 Screw drive
5 Housing body
6 Threaded spindle
7 Threaded nut
8 Coupling unit
9 Tool holder (piston rod)
10 Connection section
11 Tool device
12 Quick coupling
13 Ball latching
14 Locking ring
15 Coupling ring
16 Ball latching body
17 Opening
18 Recess
19 inner side (coupling ring)
20 Grip element
21 Control unit
22 Gear
23 Rotating shaft

1. Hand-held pulling and compression device for driving interchangeable tools, with
a drive unit comprising a battery-operated electric motor,
a screw drive with a threaded spindle connected to the drive unit and mounted rotatably on a housing body, and a threaded nut mounted rotatably on the threaded spindle and non-rotatably on the housing body via a bearing unit, and
a coupling unit connected to a tool holder for transmitting tensile and compressive forces resulting from the direction of rotation of the threaded spindle from the threaded nut to the tool holder,
wherein
the housing body has a connection section for detachable fixing of a tool device to the pulling and compression device.

2. Hand-held pulling and compression device according to claim 1, wherein the connection section has a quick coupling which can be adjusted between a locked position and an unlocked position.

3. Hand-held pulling and compression device according to claim 1, wherein the quick coupling is adjustable between the unlocked and locked position by means of an electric drive device.

4. Hand-held pulling and compression device according to claim 1, wherein the quick coupling has a ball latching with a locking ring and a coupling ring having a plurality of openings each with a ball latching body, the coupling ring arranged coaxially with the coupling ring, the coupling ring and the ball latching bodies are matched to one another in such a way that in the locked position the ball latching bodies are arranged in the openings in such a way that they project partially from an inner side of the coupling ring and are secured by the locking ring in a locked position and in the unlocked position the ball latching bodies can be displaced into a release position.

5. Hand-held pulling and compression device according to claim 1, including a locking unit fixing the locking ring in the locked position.

6. Hand-held pulling and compression device according to claim 1, wherein the locking ring is rotatable relative to the coupling ring between the locked position and the unlocked position.

7. Hand-held pulling and compression device according to claim 1, wherein the quick coupling has a sensor unit for detecting the status and a display unit connected to the sensor unit for indicating the detecting of the status.

8. Hand-held pulling and compression device according to claim 1, wherein a communication unit for transmitting the detecting of the status to the drive unit.

9. Hand-held pulling and compression device according to claim 1, wherein the quick coupling is electrically conductively connected to the drive unit.

10. Hand-held pulling and compression device according to claim 2, wherein the quick coupling is adjustable between the unlocked and locked position by means of an electric drive device.

11. Hand-held pulling and compression device according to claim 2, wherein the quick coupling has a ball latching with a locking ring and a coupling ring having a plurality of openings each with a ball latching body, the coupling ring arranged coaxially with the coupling ring, the coupling ring and the ball latching bodies are matched to one another in such a way that in the locked position the ball latching bodies are arranged in the openings in such a way that they project partially from an inner side of the coupling ring and are secured by the locking ring in a locked position and in the unlocked position the ball latching bodies can be displaced into a release position.

12. Hand-held pulling and compression device according to claim 3, wherein the quick coupling has a ball latching with a locking ring and a coupling ring having a plurality of openings each with a ball latching body, the coupling ring arranged coaxially with the coupling ring, the coupling ring and the ball latching bodies are matched to one another in such a way that in the locked position the ball latching bodies are arranged in the openings in such a way that they project partially from an inner side of the coupling ring and are secured by the locking ring in a locked position and in the unlocked position the ball latching bodies can be displaced into a release position.

13. Hand-held pulling and compression device according to claim 2, including a locking unit fixing the locking ring in the locked position.

14. Hand-held pulling and compression device according to claim 3, including a locking unit fixing the locking ring in the locked position.

15. Hand-held pulling and compression device according to claim 4, including a locking unit fixing the locking ring in the locked position.

16. Hand-held pulling and compression device according to claim 2, wherein the locking ring is rotatable relative to the coupling ring between the locked position and the unlocked position.

17. Hand-held pulling and compression device according to claim 3, wherein the locking ring is rotatable relative to the coupling ring between the locked position and the unlocked position.

18. Hand-held pulling and compression device according to claim 4, wherein the locking ring is rotatable relative to the coupling ring between the locked position and the unlocked position.

19. Hand-held pulling and compression device according to claim 2, wherein the quick coupling has a sensor unit for detecting the status and a display unit connected to the sensor unit for indicating the detecting of the status, or wherein the quick coupling is adjustable between the unlocked and locked position by means of an electric drive device.

20. Hand-held pulling and compression device according to claim 4, wherein the quick coupling has a sensor unit for detecting the status and a display unit connected to the sensor unit for indicating the detecting of the status.
